(19) United States
(12) Patent Application Publication
(10) Pub. No.: US 2023/0188981 A1
(43) Pub. Date: Jun. 15, 2023

(54) Method for Exchanging and Storing Electronic Keys

(71) Applicant: ILUMI SOLUTIONS, INC., Dallas, TX (US)

(72) Inventors: Swapnil Bora, Dallas, TX (US); Vaibhav Mistry, Dallas, TX (US)

(21) Appl. No.: 17/921,238

(22) PCT Filed: Apr. 27, 2021
(86) PCT No.: PCT/US2021/029493

§ 371 Date: Oct. 25, 2022

Related U.S. Application Data
(60) Provisional application No. 63/015,814, filed on Apr. 27, 2020.
(60) Provisional application No. 63/071,075, filed on Aug. 27, 2020.

(51) Int. Cl. H04W 12/0433; H04W 12/041; H04W 4/029

(52) U.S. Cl. CPC H04W 12/0433; H04W 12/041; H04W 4/029

(57) ABSTRACT

In one example, a first wireless device transmits one or more electronic keys, and a second wireless device receives and stores the electronic key(s) in a memory. A server or a user device uploads, receives or synchronizes the electronic key(s) from the second wireless device. In another example, one or more electronic keys are transmitted using a first wireless device, the electronic key(s) are received and stored in a memory of a second wireless device, and the electronic key(s) or other data are transmitted, uploaded or synchronized to a server or a user device. In another example, a device comprises: a wireless transceiver; a memory; and a processor communicably coupled to the wireless transceiver and the memory, wherein the processor receives one or more electronic keys from one or more wireless devices, and stores the electronic key(s) in the memory.

### CROSS-REFERENCE TO RELATED APPLICATIONS

This patent application claims priority to: (1) U.S. Provisional Patent Application Ser. No. 63/015,814, filed on Apr. 27, 2020, and entitled “Method for Exchanging and Storing Electronic Keys”; and (2) U.S. Provisional Patent Application Ser. No. 63/071,075, filed on Aug. 27, 2020, and entitled “Method for Exchanging and Storing Electronic Keys”. The foregoing applications are hereby incorporated by reference in their entirety.

This patent application is related to U.S. patent application Ser. No. 16/853,599, filed on Apr. 20, 2020, and entitled “Electronic Control Device”, which is a continuation patent application of U.S. patent application Ser. No. 15/204,901, filed on Jul. 7, 2016, and entitled “Wireless Lighting Control Methods”, now U.S. Pat. No. 10,630,820, which claims priority to U.S. Provisional Patent Application Ser. No. 62/189,637, filed on Jul. 7, 2015, and entitled “Wireless Lighting Control Methods”. The foregoing patents and applications are hereby incorporated by reference in their entirety.

In addition, this application is related to U.S. patent application Ser. No. 14/175,322, filed on Feb. 7, 2014, and entitled “Wireless Lighting Control Methods”, which is a continuation patent application of U.S. patent application Ser. No. 14/077,200, filed on Nov. 11, 2013, and entitled “Wireless Lighting Control System”, which is: (1) a non-provisional patent application of U.S. Provisional Patent Application Ser. No. 61/724,651, filed on Nov. 9, 2012, and entitled “Wireless Lighting Control System”; and (2) a continuation-in-part application of U.S. patent application Ser. No. 13/836,280, filed on Mar. 15, 2013, now U.S. Pat. No. 8,922,126 B2, and entitled “Wireless Lighting Control System”, which (a) is a continuation application of U.S. patent application Ser. No. 13/417,322, filed Mar. 11, 2012, now U.S. Pat. No. 8,890,435 B2, and entitled “Wireless Lighting Control System”, which is a non-provisional patent application of U.S. Provisional Application Ser. No. 61/464,917, filed Mar. 11, 2011, and entitled “Specialty Lighting and Control Therefor”, and (b) claimed priority to PCT Patent Application Serial Number PCT/US2012/037369, filed May 10, 2012, and entitled “Wireless Lighting Control System.” The foregoing patents and patent applications are hereby incorporated by reference in their entirety.

This application is also related to: (1) U.S. patent application Ser. No. 13/837,232, filed on Mar. 15, 2013, now U.S. Pat. No. 8,742,694 B2, and entitled “Wireless Lighting Control System”; (2) U.S. patent application Ser. No. 13/838,648, filed on Mar. 15, 2013, now U.S. Pat. No. 8,896,232 B2, and entitled “Wireless Lighting Control System”; and (3) U.S. patent application Ser. No. 13/839,738, filed on Mar. 15, 2013, now U.S. Pat. No. 8,896,218 B2, and entitled “Wireless Lighting Control System”. The foregoing patents and patent applications are hereby incorporated by reference in their entirety.

### FIELD OF THE INVENTION

The present invention relates generally to the field of wireless communications and, more particularly, to a system and method for exchanging and storing electronic keys.

### BACKGROUND OF THE INVENTION

None.

### SUMMARY OF THE INVENTION

Anonymous and encrypted key based contact tracing and exposure notification has various benefits and applications including finding exposure to viruses during the pandemic, tracking and monitoring of living and non-living things while preserving the privacy. With advancement of wireless technologies such as Bluetooth, such tracing and tracking solutions provide an opportunity to reduce risks by providing additional precautionary majors that are easy to deploy. However, to overcome various challenges with respect to accommodating various groups with no easy access to such wireless technologies cost effectively and making easier adoption for safe and secured environment is what various embodiments described herein focus on.

In one embodiment of the present invention, a device comprises a wireless transceiver, a memory, and a processor communicably coupled to the wireless transceiver and the memory. The processor receives one or more electronic keys from one or more wireless devices, and stores the one or more electronic keys in the memory.

In one aspect, the one or more electronic keys comprise a device identification, an anonymous identification, or a person identification; or the one or more electronic keys are encrypted. In another aspect, the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value. In another aspect, each electronic key is contained in one or more data packets. In another aspect, the processor adds a data, a flag or a stamp to the one or more electronic keys, and the data, the flag or the stamp comprises a second identifier, a location, a time, a start time, an end time, a date, a duration, a signal strength, a frequency, a severity, a device type, a transmission power, a RSSI vale, a GPS coordinate, a version number, a sensor data, or a priority value. In another aspect, the processor increases or decreases the priority value of the electronic key based on a number of electronic keys received from one of the wireless devices. In another aspect, the priority value comprises a numerical value, a flag value, or a memory location. In another aspect, the processor deletes at least one of the one or more electronic keys stored in the memory whenever the memory has reached a defined storage limit. In another aspect, the processor selects the at least one of the one or more electronic keys for deletion based on a duplication of electronic keys, the duplication of electronic keys within a time period, a number of duplicate electronic keys within the time period, an elapsed time from receiving the electronic key, a priority value associated with the electronic key, a first-in, first-out basis, or a selected data, flag or stamp. In another aspect, the processor adjusts a signal strength or a RSSI value between the one or more wireless devices such that additional electronic keys are not received from the one or more wireless devices or are filtered out. In another aspect, the processor transmits, uploads or synchronizes one or more of the electronic keys or data stored in the memory to a server or user device. In another aspect, the one or more of the electronic keys or data are transmitted, uploaded or synchronized to the server via another device or the user device. In another aspect, the processor transmits, uploads or synchronizes the electronic key(s) simultaneously, sequentially, based on a priority value, a trigger, an event, a user-defined setting or a default setting. In another aspect, the processor receives an acknowledgment from the server or the user device. In another aspect, the processor receives and updates a configuration data, one or more parameters or a firmware. In another aspect, the processor adjusts a signal power of the transceiver to limit, increase or decrease a range. In another aspect, the transceiver is communicably coupled to the one or more wireless devices directly or via a network. In another aspect, the device further comprises a real time clock, a timer, a counter, a battery, a sensor, or a user interface communicably coupled to the processor. In another aspect, the device or the one or more wireless devices comprise a sensor, a beacon device, a tracking device, a mobile device, a wearable device, a controller, a phone, a gateway, an access point, a repeater, a computer, a lighting device, a wall-mounted device, a ceiling-mounted device, a floor-mounted device, a plug, or a dongle. In another aspect, the processor and a server generate the same electronic keys. In another aspect, the processor receives one or more computer programs from a user device having a user interface and running a computer application. In another aspect, the one or more programs, when executed by the processor, adjust a gain, adjust a transmission range, reset the device, synchronize a date or time, update a firmware, reset the memory, edit a group, edit other device configurations, edit broadcasting parameters, edit a network, perform commissioning, preform a setup process, edit user access, set light indications, or set priority configurations. In another aspect, the one or more electronic keys stored in the memory of the device with are compared with one or more additional electronic keys stored on a server or a user device. In another aspect, a notification is provided after the one or more electronic keys stored in the memory of the device match the one or more additional electronic keys stored on the server or the user device. In another aspect, the notification comprises an email, a text message, or an automated phone call. In another aspect, the notification includes a link to a website, written instructions, or written information. In another aspect, the processor generates additional electronic keys based on one or more configuration parameters. In another aspect, a real time clock in the device, one of the one or more wireless devices, or both wireless devices are synchronized with a reference time.

In another embodiment of the present invention, a method for transmitting and receiving one or more electronic keys comprises: transmitting one or more electronic keys using a first wireless device; receiving the one or more electronic keys at a second wireless device; storing the one or more electronic keys in a memory of the second wireless device; and transmitting, uploading or synchronizing the one or more electronic keys or other data stored in the memory of the second wireless device to a server or a user device.

In one aspect, the one or more electronic keys comprise a device identification, an anonymous identification, or a person identification; or the one or more electronic keys are encrypted. In another aspect, the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value. In another aspect, each electronic key is contained in one or more data packets. In another aspect, the method further comprises adding a data, a flag or a stamp to the one or more electronic keys, and the data, the flag or the stamp comprises a second identifier, a location, a time, a start time, an end time, a date, a duration, a signal strength, a frequency, a severity, a device type, a transmission power, a RSSI vale, a GPS coordinate, a version number, a sensor data, or a priority value. In another aspect, the method further comprises increasing or decreasing the priority value of the electronic key based on a number of electronic keys received from first wireless device. In another aspect, the priority value comprises a numerical value, a flag value, or a memory location. In another aspect, the method further comprises deleting at least one of the one or more electronic keys stored in the memory whenever the memory has reached a defined storage limit. In another aspect, the method further comprises selecting the at least one of the one or more electronic keys for deletion based on a duplication of electronic keys, the duplication of electronic keys within a time period, a number of duplicate electronic keys within the time period, an elapsed time from receiving the electronic key, a priority value associated with the electronic key, a first-in, first-out basis, or a selected data, flag or stamp. In another aspect, the method further comprises adjusting a signal strength or a RSSI value of the second wireless device such that additional electronic keys are not received from the first wireless device or are filtered out. In another aspect, the stored electronic keys or other data are transmitted, uploaded or synchronized to the server via another device or the user device. In another aspect, the electronic key(s) are transmitted, uploaded or synchronized simultaneously, sequentially, based on a priority value, a trigger, an event, a user-defined setting or a default setting. In another aspect, the method further comprises receiving an acknowledgment from the server or the user device. In another aspect, the method further comprises receiving and updating a configuration data, one or more parameters or a firmware. In another aspect, the method further comprises adjusting a signal power to limit, increase or decrease a range. In another aspect, the first wireless device is communicably coupled to the second wireless device directly or via a network. In another aspect, the second wireless device includes a real time clock, a timer, a counter, a battery, a sensor, or a user interface communicably coupled to a processor. In another aspect, the first wireless device or the second wireless device comprises a sensor, a beacon device, a tracking device, a mobile device, a wearable device, a controller, a phone, a gateway, an access point, a repeater, a computer, a lighting device, a wall-mounted device, a ceiling-mounted device, a floor-mounted device, a plug, or a dongle. In another aspect, the first wireless device or the second wireless, and the server or the user device generate the same electronic keys. In another aspect, the method further comprises receiving one or more computer programs at the second wireless device from the user device having a user interface and running a computer application. In another aspect, the one or more programs, when executed by the processor, adjust a gain, adjust a transmission range, reset the device, synchronize a date or time, update a firmware, reset the memory, edit a group, edit other device configurations, edit broadcasting parameters, edit a network, perform commissioning, preform a setup process, edit user access, set light indications, or set priority configurations. In another aspect, the method further comprises comparing the one or more electronic keys stored in the memory of the second wireless device with one or more additional electronic keys stored on the server or the user device. In another aspect, the method further comprises providing a notification after the one or more electronic keys stored in the memory of the second wireless device match the one or more additional electronic keys stored on the server or the user device. In another aspect, the notification comprises an email, a text message, or an automated phone call. In another aspect, the notification includes a link to a website, written instructions, or written information. In another aspect, the method further comprises generating additional electronic keys based on one or more configuration parameters. In another aspect, the method further comprises synchronizing a real time clock in the first wireless device, the second wireless device, or both wireless devices with a reference time.

In another embodiment of the present invention, a system comprises: a first wireless device that transmits one or more electronic keys; a second wireless device that receives the one or more electronic keys from the first wireless device, and stores the one or more electronic keys in a memory of the second wireless device; and a server or a user device that uploads, receives or synchronizes the one or more electronic keys from the second wireless device.

In one aspect, the one or more electronic keys comprise a device identification, an anonymous identification, or a person identification; or the one or more electronic keys are encrypted. In another aspect, the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value. In another aspect, each electronic key is contained in one or more data packets. In another aspect, the second wireless device adds a data, a flag or a stamp to the one or more electronic keys, and the data, the flag or the stamp comprises a second identifier, a location, a time, a start time, an end time, a date, a duration, a signal strength, a frequency, a severity, a device type, a transmission power, a RSSI vale, a GPS coordinate, a version number, a sensor data, or a priority value. In another aspect, the second wireless device increases or decreases the priority value of the electronic key based on a number of electronic keys received from the first wireless device. In another aspect, the priority value comprises a numerical value, a flag value, or a memory location. In another aspect, the second wireless device deletes at least one of the one or more electronic keys stored in the memory whenever the memory has reached a defined storage limit. In another aspect, the second wireless device selects the at least one of the one or more electronic keys for deletion based on a duplication of electronic keys, the duplication of electronic keys within a time period, a number of duplicate electronic keys within the time period, an elapsed time from receiving the electronic key, a priority value associated with the electronic key, a first-in, first-out basis, or a selected data, flag or stamp. In another aspect, the second wireless device adjusts a signal strength or a RSSI value between the one or more wireless devices such that additional electronic keys are not received from the first wireless device or are filtered out. In another aspect, the one or more of the electronic keys or data are transmitted, uploaded or synchronized to the server via another device or the user device. In another aspect, the second wireless device transmits, uploads or synchronizes the electronic key(s) simultaneously, sequentially, based on a priority value, a trigger, an event, a user-defined setting or a default setting. In another aspect, the second wireless device receives an acknowledgment from the server or the user device. In another aspect, the second wireless device receives and updates a configuration data, one or more parameters or a firmware. In another aspect, the second wireless device adjusts a signal power of the transceiver to limit, increase or decrease a range. In another aspect, the second wireless device is communicably coupled to the first wireless device directly or via a network. In another aspect, the second wireless device includes a real time clock, a timer, a counter, a battery, a sensor, or a user interface communicably coupled to the processor. In another aspect, the first wireless device or the second wireless device comprises a sensor, a beacon device, a tracking device, a mobile device, a wearable device, a controller, a phone, a gateway, an access point, a repeater, a computer, a lighting device, a wall-mounted device, a ceiling-mounted device, a floor-mounted device, a plug, or a dongle. In another aspect, the second wireless device and the server generate the same electronic keys. In another aspect, the second wireless device receives one or more computer programs from the user device having a user interface and running a computer application. In another aspect, the one or more programs, when executed by the second wireless device, adjust a gain, adjust a transmission range, reset the device, synchronize a date or time, update a firmware, reset the memory, edit a group, edit other device configurations, edit broadcasting parameters, edit a network, perform commissioning, preform a setup process, edit user access, set light indications, or set priority configurations. In another aspect, the second wireless device generates additional electronic keys based on one or more configuration parameters. In another aspect, the one or more electronic keys stored in the memory of the second wireless device are compared with one or more additional electronic keys from the server or the user device. In another aspect, a notification is provided after the one or more electronic keys stored in the memory of the second wireless device match the one or more additional electronic keys stored on the server or the user device. In another aspect, the notification comprises an email, a text message, or an automated phone call. In another aspect, the notification includes a link to a website, written instructions, or written information. In another aspect, a real time clock in the first wireless device, the second wireless device, or both wireless devices are synchronized with a reference time.

These and other objects, advantages and features of this invention will be apparent from the following description taken with reference to the accompanying drawing, wherein is shown a preferred embodiment of the invention.

### BRIEF DESCRIPTION OF THE DRAWINGS

The above and further advantages of the invention may be better understood by referring to the following description in conjunction with the accompanying drawings, in which:

FIG. 1 is a block diagram of a device in accordance with one embodiment of the present invention;

FIG. 2 is a flow chart of a method for exchanging and storing electronic keys in accordance with one embodiment of the present invention;

FIG. 3 is a flow chart of a key exchange and storing program in accordance with one embodiment of the present invention;

FIG. 4 is a flow chart of a key exchange and broadcasting/communicate program in accordance with one embodiment of the present invention;

FIG. 5 is a flow chart of gain adjustment in accordance with one embodiment of the present invention;

FIG. 6 is a flow chart of data synching flow in accordance with one embodiment of the present invention;

FIGS. 7A, 7B and 7C are block diagrams of various programs in accordance with one embodiment of the present invention;

FIG. 8 is a block diagram of a static device in accordance with one embodiment of the present invention;

FIG. 9 is a flow chart of key storage, retrieval, and transmission in accordance with one embodiment of the present invention;

FIG. 10 is a process flow for key storage and retrieval in accordance with one embodiment of the present invention;

FIGS. 11A and 11B are block diagrams of device selection and group selection, respectively, in accordance with one embodiment of the present invention;

FIG. 12 is a flow chart of device configuration in accordance with one embodiment of the present invention;

FIG. 13 is a flow chart of configuring a device with various parameters in accordance with one embodiment of the present invention;

FIG. 14 is a block diagram of contact tracing application data flow in accordance with one embodiment of the present invention;

FIG. 15 is a block diagram of contact tracing/exposure notification application process in accordance with one embodiment of the present invention; and

FIG. 16 is a block diagram of wearable device synching keys via powered device in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

Anonymous and encrypted key based contact tracing and exposure notification has various benefits and applications including finding exposure to viruses during the pandemic, tracking and monitoring of living and non-living things while preserving the privacy. With advancement of wireless technologies such as Bluetooth, such tracing and tracking solutions provide an opportunity to reduce risks by providing additional precautionary majors that are easy to deploy. However, to overcome various challenges with respect to accommodating various groups with no easy access to such wireless technologies cost effectively and making easier adoption for safe and secured environment is what various embodiments described herein focus on.

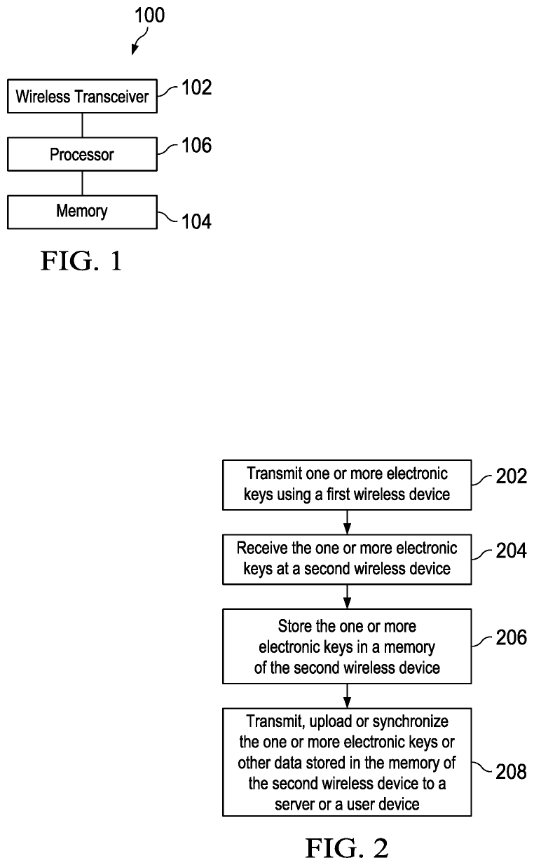

Now referring to FIG. 1, a device 100 in accordance with one embodiment of the present invention is shown. The device 100 includes a wireless transceiver 102, a memory 104, and a processor 106 communicably coupled to the wireless transceiver 102 and the memory 104. The processor 106 receives one or more electronic keys from one or more wireless devices, and stores the one or more electronic keys in the memory 104. The wireless device 100 can be handheld, mobile, wearable, stationary, moveable and/or a part or component of another device. In addition, the wireless device 100 can optionally include other components known or conceivable to those skilled in the art now or in the future. As used herein the terms “processor” and “controller” are interchangeable any may include any type of hardware, software or combination thereof that controls, operates and/or runs all or part of a device.

In one aspect, the one or more electronic keys comprise a device identification, an anonymous identification, or a person identification; or the one or more electronic keys are encrypted. In another aspect, the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value. In another aspect, each electronic key is contained in one or more data packets. In another aspect, the processor adds a data, a flag or a stamp to the one or more electronic keys, and the data, the flag or the stamp comprises a second identifier, a location, a time, a start time, an end time, a date, a duration, a signal strength, a frequency, a severity, a device type, a transmission power, a RSSI vale, a GPS coordinate, a version number, a sensor data, or a priority value. In another aspect, the processor increases or decreases the priority value of the electronic key based on a number of electronic keys received from one of the wireless devices. In another aspect, the priority value comprises a numerical value, a flag value, or a memory location. In another aspect, the processor deletes at least one of the one or more electronic keys stored in the memory whenever the memory has reached a defined storage limit. In another aspect, the processor selects the at least one of the one or more electronic keys for deletion based on a duplication of electronic keys, the duplication of electronic keys within a time period, a number of duplicate electronic keys within the time period, an elapsed time from receiving the electronic key, a priority value associated with the electronic key, a first-in, first-out basis, or a selected data, flag or stamp. In another aspect, the processor adjusts a signal strength or a RSSI value between the one or more wireless devices such that additional electronic keys are not received from the one or more wireless devices or are filtered out. In another aspect, the processor transmits, uploads or synchronizes one or more of the electronic keys or data stored in the memory to a server or user device. In another aspect, the one or more of the electronic keys or data are transmitted, uploaded or synchronized to the server via another device or the user device. In another aspect, the processor transmits, uploads or synchronizes the electronic key(s) simultaneously, sequentially, based on a priority value, a trigger, an event, a user-defined setting or a default setting. In another aspect, the processor receives an acknowledgment from the server or the user device. In another aspect, the processor receives and updates a configuration data, one or more parameters or a firmware. In another aspect, the processor adjusts a signal power of the transceiver to limit, increase or decrease a range. In another aspect, the transceiver is communicably coupled to the one or more wireless devices directly or via a network. In another aspect, the device further comprises a real time clock, a timer, a counter, a battery, a sensor, or a user interface communicably coupled to the processor. In another aspect, the device or the one or more wireless devices comprise a sensor, a beacon device, a tracking device, a mobile device, a wearable device, a controller, a phone, a gateway, an access point, a repeater, a computer, a lighting device, a wall-mounted device, a ceiling-mounted device, a floor-mounted device, a plug, or a dongle. In another aspect, the processor and a server generate the same electronic keys. In another aspect, the processor receives one or more computer programs from a user device having a user interface and running a computer application. In another aspect, the one or more programs, when executed by the processor, adjust a gain, adjust a transmission range, reset the device, synchronize a date or time, update a firmware, reset the memory, edit a group, edit other device configurations, edit broadcasting parameters, edit a network, perform commissioning, preform a setup process, edit user access, set light indications, or set priority configurations. In another aspect, the one or more electronic keys stored in the memory of the device with are compared with one or more additional electronic keys stored on a server or a user device. In another aspect, a notification is provided after the one or more electronic keys stored in the memory of the device match the one or more additional electronic keys stored on the server or the user device. In another aspect, the notification comprises an email, a text message, or an automated phone call. In another aspect, the notification includes a link to a website, written instructions, or written information. In another aspect, the processor generates additional electronic keys based on one or more configuration parameters. In another aspect, a real time clock in the device, one of the one or more wireless devices, or both wireless devices are synchronized with a reference time.

Now referring to FIG. 2, a flow chart of a method for exchanging and storing electronic keys in accordance with one embodiment of the present invention is shown. The method for transmitting and receiving one or more electronic keys comprises: transmitting one or more electronic keys using a first wireless device in block 202; receiving the one or more electronic keys at a second wireless device in block 204; storing the one or more electronic keys in a memory of the second wireless device in block 206; and transmitting, uploading or synchronizing the one or more electronic keys or other data stored in the memory of the second wireless device to a server or a user device in block 208.

In one aspect, the one or more electronic keys comprise a device identification, an anonymous identification, or a person identification; or the one or more electronic keys are encrypted. In another aspect, the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value. In another aspect, each electronic key is contained in one or more data packets. In another aspect, the method further comprises adding a data, a flag or a stamp to the one or more electronic keys, and the data, the flag or the stamp comprises a second identifier, a location, a time, a start time, an end time, a date, a duration, a signal strength, a frequency, a severity, a device type, a transmission power, a RSSI vale, a GPS coordinate, a version number, a sensor data, or a priority value. In another aspect, the method further comprises increasing or decreasing the priority value of the electronic key based on a number of electronic keys received from first wireless device. In another aspect, the priority value comprises a numerical value, a flag value, or a memory location. In another aspect, the method further comprises deleting at least one of the one or more electronic keys stored in the memory whenever the memory has reached a defined storage limit. In another aspect, the method further comprises selecting the at least one of the one or more electronic keys for deletion based on a duplication of electronic keys, the duplication of electronic keys within a time period, a number of duplicate electronic keys within the time period, an elapsed time from receiving the electronic key, a priority value associated with the electronic key, a first-in, first-out basis, or a selected data, flag or stamp. In another aspect, the method further comprises adjusting a signal strength or a RSSI value of the second wireless device such that additional electronic keys are not received from the first wireless device or are filtered out. In another aspect, the stored electronic keys or other data are transmitted, uploaded or synchronized to the server via another device or the user device. In another aspect, the electronic key(s) are transmitted, uploaded or synchronized simultaneously, sequentially, based on a priority value, a trigger, an event, a user-defined setting or a default setting. In another aspect, the method further comprises receiving an acknowledgment from the server or the user device. In another aspect, the method further comprises receiving and updating a configuration data, one or more parameters or a firmware. In another aspect, the method further comprises adjusting a signal power to limit, increase or decrease a range. In another aspect, the first wireless device is communicably coupled to the second wireless device directly or via a network. In another aspect, the second wireless device includes a real time clock, a timer, a counter, a battery, a sensor, or a user interface communicably coupled to a processor. In another aspect, the first wireless device or the second wireless device comprises a sensor, a beacon device, a tracking device, a mobile device, a wearable device, a controller, a phone, a gateway, an access point, a repeater, a computer, a lighting device, a wall-mounted device, a ceiling-mounted device, a floor-mounted device, a plug, or a dongle. In another aspect, the first wireless device or the second wireless, and the server or the user device generate the same electronic keys. In another aspect, the method further comprises receiving one or more computer programs at the second wireless device from the user device having a user interface and running a computer application. In another aspect, the one or more programs, when executed by the processor, adjust a gain, adjust a transmission range, reset the device, synchronize a date or time, update a firmware, reset the memory, edit a group, edit other device configurations, edit broadcasting parameters, edit a network, perform commissioning, preform a setup process, edit user access, set light indications, or set priority configurations. In another aspect, the method further comprises comparing the one or more electronic keys stored in the memory of the second wireless device with one or more additional electronic keys stored on the server or the user device. In another aspect, the method further comprises providing a notification after the one or more electronic keys stored in the memory of the second wireless device match the one or more additional electronic keys stored on the server or the user device. In another aspect, the notification comprises an email, a text message, or an automated phone call. In another aspect, the notification includes a link to a website, written instructions, or written information. In another aspect, the method further comprises generating additional electronic keys based on one or more configuration parameters. In another aspect, the method further comprises synchronizing a real time clock in the first wireless device, the second wireless device, or both wireless devices with a reference time.

As will be illustrated below in various embodiments of the present invention, a system comprises: a first wireless device that transmits one or more electronic keys; a second wireless device that receives the one or more electronic keys from the first wireless device, and stores the one or more electronic keys in a memory of the second wireless device; and a server or a user device that uploads, receives or synchronizes the one or more electronic keys from the second wireless device.

In one aspect, the one or more electronic keys comprise a device identification, an anonymous identification, or a person identification; or the one or more electronic keys are encrypted. In another aspect, the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value. In another aspect, each electronic key is contained in one or more data packets. In another aspect, the second wireless device adds a data, a flag or a stamp to the one or more electronic keys, and the data, the flag or the stamp comprises a second identifier, a location, a time, a start time, an end time, a date, a duration, a signal strength, a frequency, a severity, a device type, a transmission power, a RSSI vale, a GPS coordinate, a version number, a sensor data, or a priority value. In another aspect, the second wireless device increases or decreases the priority value of the electronic key based on a number of electronic keys received from the first wireless device. In another aspect, the priority value comprises a numerical value, a flag value, or a memory location. In another aspect, the second wireless device deletes at least one of the one or more electronic keys stored in the memory whenever the memory has reached a defined storage limit. In another aspect, the second wireless device selects the at least one of the one or more electronic keys for deletion based on a duplication of electronic keys, the duplication of electronic keys within a time period, a number of duplicate electronic keys within the time period, an elapsed time from receiving the electronic key, a priority value associated with the electronic key, a first-in, first-out basis, or a selected data, flag or stamp. In another aspect, the second wireless device adjusts a signal strength or a RSSI value between the one or more wireless devices such that additional electronic keys are not received from the first wireless device or are filtered out. In another aspect, the one or more of the electronic keys or data are transmitted, uploaded or synchronized to the server via another device or the user device. In another aspect, the second wireless device transmits, uploads or synchronizes the electronic key(s) simultaneously, sequentially, based on a priority value, a trigger, an event, a user-defined setting or a default setting. In another aspect, the second wireless device receives an acknowledgment from the server or the user device. In another aspect, the second wireless device receives and updates a configuration data, one or more parameters or a firmware. In another aspect, the second wireless device adjusts a signal power of the transceiver to limit, increase or decrease a range. In another aspect, the second wireless device is communicably coupled to the first wireless device directly or via a network. In another aspect, the second wireless device includes a real time clock, a timer, a counter, a battery, a sensor, or a user interface communicably coupled to the processor. In another aspect, the first wireless device or the second wireless device comprises a sensor, a beacon device, a tracking device, a mobile device, a wearable device, a controller, a phone, a gateway, an access point, a repeater, a computer, a lighting device, a wall-mounted device, a ceiling-mounted device, a floor-mounted device, a plug, or a dongle. In another aspect, the second wireless device and the server generate the same electronic keys. In another aspect, the second wireless device receives one or more computer programs from the user device having a user interface and running a computer application. In another aspect, the one or more programs, when executed by the second wireless device, adjust a gain, adjust a transmission range, reset the device, synchronize a date or time, update a firmware, reset the memory, edit a group, edit other device configurations, edit broadcasting parameters, edit a network, perform commissioning, preform a setup process, edit user access, set light indications, or set priority configurations. In another aspect, the second wireless device generates additional electronic keys based on one or more configuration parameters. In another aspect, the one or more electronic keys stored in the memory of the second wireless device are compared with one or more additional electronic keys from the server or the user device. In another aspect, a notification is provided after the one or more electronic keys stored in the memory of the second wireless device match the one or more additional electronic keys stored on the server or the user device. In another aspect, the notification comprises an email, a text message, or an automated phone call. In another aspect, the notification includes a link to a website, written instructions, or written information. In another aspect, a real time clock in the first wireless device, the second wireless device, or both wireless devices are synchronized with a reference time.

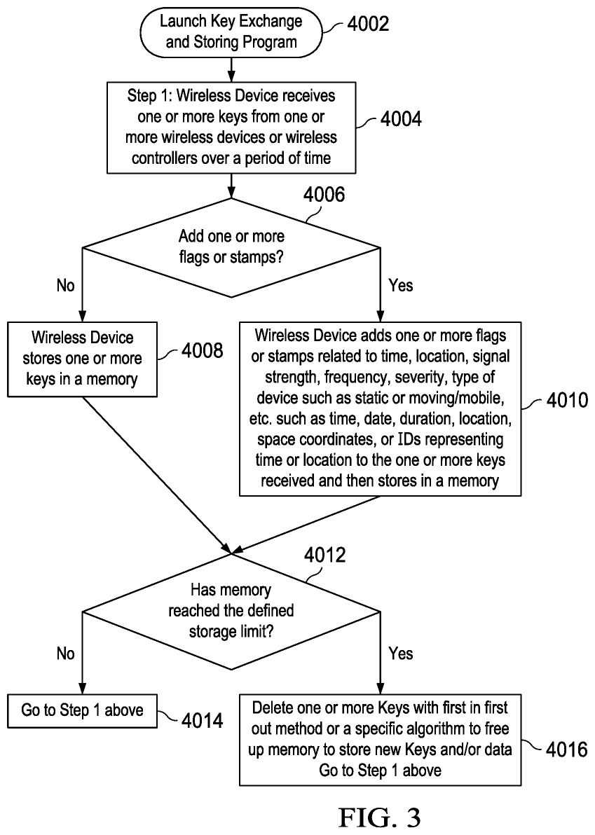

In FIG. 3, a Key exchange and storing program is shown. The program resides in a controller/processor. The controller/processor can have this program as a manufacturing default, or a user can upload it via an application with a user interface either as a new program or as a part of a firmware update.

The program receives one or more Keys from nearby devices 4004.

Keys can be but not limited to a one or more device IDs, anonymous ID, ID representing one or more persons or one or more devices including but not limited to one or more sensors, static devices such as beacon and tracking devices, mobile devices such as remote controlling devices like smartphones, remote controllers, gateways, or a combination thereof. The ID can have data fields for but not limited to personal identification, location, time, date, duration, signal strength; static, mobile device or remote controller devices identification and data, transmission power, RSSI value, GPS coordinates, one or more version numbers, sensor data including but not limited to temperature, humidity, air quality, or any other data generated by a transmitting device such as intelligent illuminating device or a sensor device referred in referred previous patents and applications incorporated by reference. Key can also have various flags or data fields which can be programmed or adjusted to indicate various parameters or conditions such as if it is a mobile/moving device or a static device, and consists of a specific data there or not. Static device can be a smart wall plug in the form of a plug or a dongle as in

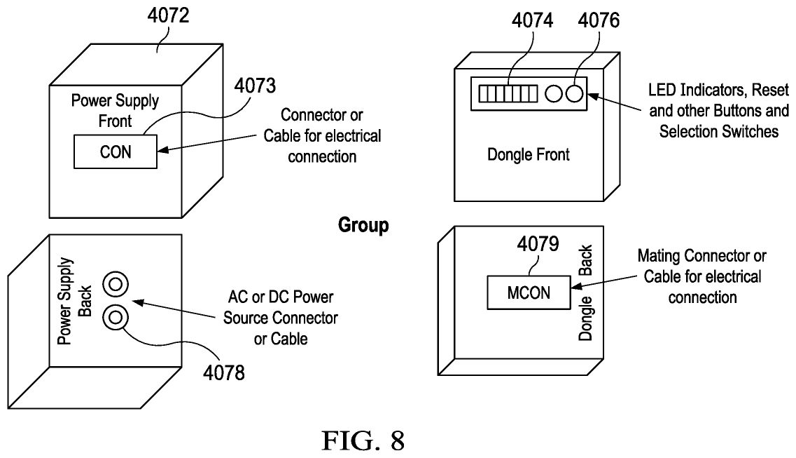

FIG. 8, smart bulb, beacon, or other device with wireless system and controller/processor integrated into it.

Each key can be one packet or multiple packets as per the defined wireless protocol. The keys can also be encrypted.

Various keys are transmitted by various devices whether mobile or static. In case the key doesn't have any time and/or date of the transmission, the receiving wireless device can add a flag and/or a stamp to define the time and/or date or any such parameter such as location as stated above. The key along with its stamps is stored at a specific memory location. Similarly, the next key received from the same or another device is stored in the subsequent memory location or a memory location defined by a program and the process continues, as stated in in operation 4010.

As in operation 4012 and 4016, in case, the memory storage is full, the memory is freed up by deleting the keys in the memory under the first in first out basis or with specific algorithms based on filtering as explained below.

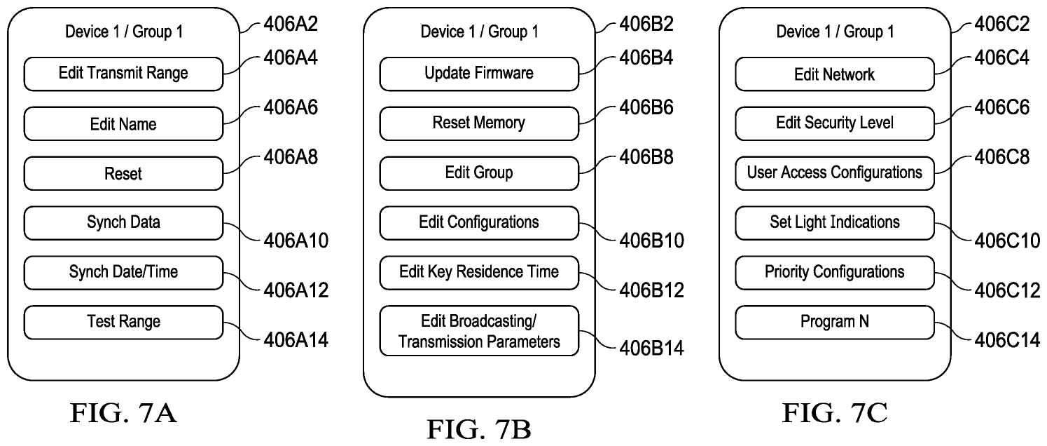

In many instances, the keys received could be duplicates. For example, a device might keep receiving the same keys a few times from nearby static devices which need to be filtered out. It can be done by
1. Having a specific flag or a field with a specific data that would confirm the key is from a specific type of a device nearby and thus deleting the specific keys.
2. Having the signal strength between two devices adjusted so that they are not able to read the keys transmitted by each other.
3. Having the signal strength between two devices adjusted (potentially to a lower value or a much higher value) so that they can filter the keys transmitted by each other.
4. Having an additional broadcast or transmission suggesting a specific key was with a specific data field was sent by a specific static device or a specific type of a device from which one or more specific keys can be filtered out, deleted or ignored.
5. The receiving device delete the repeat entries as per the algorithm.
6. The receiving device delete the entries based on the how many times it has received one or more keys from devices in given duration.
7. The receiving device can also filter out or delete one or more keys based on how much time has passed after receiving those keys. For example, delete all keys after certain time, say 6 hours.
   a. Such time threshold can be based on the manufacturing default or user programmed such as Key Residence Time Program as shown in FIG. 7B.
8. The receiving device can also filter out or delete one or more keys based on priority values, time elapsed since receiving it, any other parameter defined above or a combination thereof.

Above parameters can also be used to prioritize the keys in a memory. For example:
1. A repeat key from a mobile device multiple times for a longer duration signifies that the mobile device was in proximity of the receiving device for a longer duration which can be treated as per a specific algorithm as an important key and thus a higher priority ID or a higher priority memory location or a higher priority flag.
2. A key with an older time stamp could be assigned a lower priority ID or a lower priority memory location or a lower priority flag.

The priorities set as above and for other reasons, could be used to delete the keys from memory as in operation 4016 to free it up for newer keys or data. As in the FIG. 3, the receiving of one or more Keys and deletion continues.

In addition, above defined priorities or additional programs can add new data into the key or create additional keys or data messages stored in the memory. These additional data into one more keys or new data fields may have below but not limited to the information/data:
1. Duration how long a mobile device was nearby the receiving controller/processor.
2. Start time and/or end time of mobile device based on when one or more keys were received by controller processor
3. Visibility data such as how many other controllers/processors in the same vicinity or nearby vicinities have received one or more keys from a particular mobile device.
4. Severity data defined by specific keys which are flagged by user or one or more organizations of which application the user is using. This severity data can be added based on the comparison with various keys stored on the server, a controlling device or provided to the device who is receiving keys and storing those by one or more user applications or remote controlling devices including smart phone, gateway, etc.
5. This data can also accommodate data from one or more sensors communicating with a device storing keys in memory.
   a. The sensor data received can itself be a key or a data packet being used to store in memory locations as defined above.
   b. Sensor data can also be prioritized, filtered, deleted or adjusted in a similar way as defined above for one or more Keys.
6. Any other one or more data fields of one or more flags that can be accommodated.

This data can also be used for Light Indications having LEDs turn to a specific color, brightness or an effect.

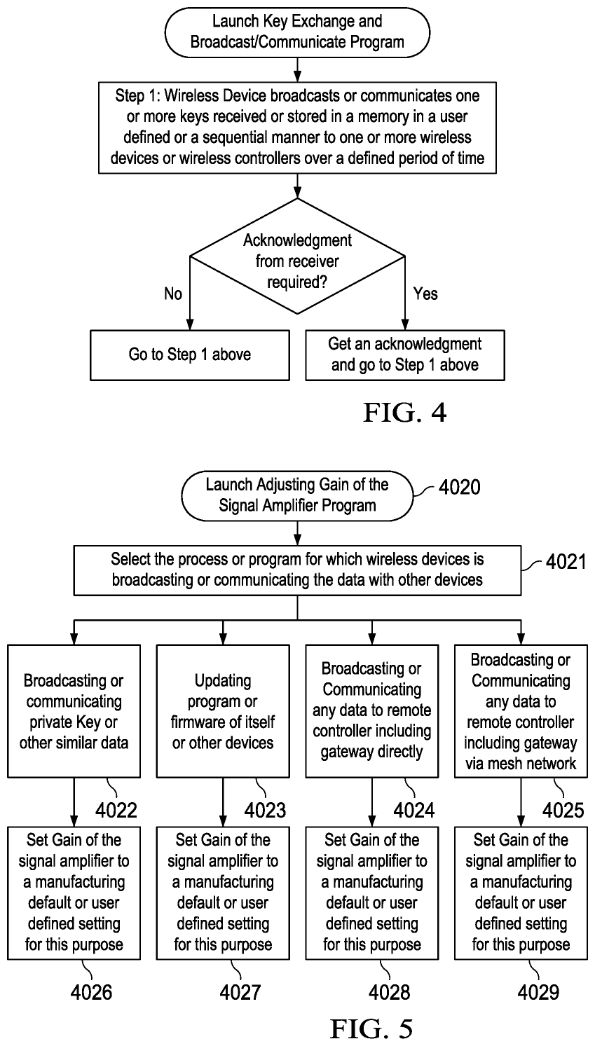

FIG. 4 shows broadcasting or communicating various keys stored in the memory to one or more devices around including intelligent illuminating devices, mobile device, wireless remote controllers such as mobile devices. In the process the device broadcasts or communicates with an established wireless link, the keys one by one either sequentially or based on the priority defined by the one or more programs.

The receiving device gets the keys and performs the action as per the program it is running.

The device can perform actions in FIGS. 3 and 4 simultaneously or sequentially with a default time gap or user configured time gap or based on a specific trigger.

The device can perform actions such as receiving one or more keys and broadcasting or communicating one or more keys simultaneously or sequentially. The actions can also be triggered by other actions. For example, the device will broadcast or communicate only when it receives a key from another device, which also acts as a trigger.

When one or more keys are broadcasted or transmitted to a receiving device, a receiving device may acknowledge the receipt by broadcasting or communicating another message or so. In this case, if a first broadcasting device doesn't receive an acknowledgement message, it may, based on the program, try rebroadcasting or communicating one or more keys to the other device. The broadcasting or communicating the messages would otherwise continue as shown in the FIG. 4.

FIG. 5 describes a process of adjusting the gain of signal amplifier in various scenarios.

In many scenarios, there might be a requirement to ensure the power of the transmitted signal from the device follows a certain limit, so the signal doesn't reach to many devices beyond the required range. Or there might be a requirement where the power of the transmitted signal from the device is high enough so it reaches to various devices at a specific range. Various programs such as in operations 4022, 4023, 4024, 4025 running might define the signal power and thus the gain as per the respective program requirements or a combination thereof. The gain might be adjusted dynamically as and when various programs execute the signal transmission part of it and requires different signal strength or transmission power. A gain adjust or similar program can be run by entering into the Edit Transmit Range option on user interface shown in FIG. 7A.

The programs can include but not limited to Broadcasting or communicating one or more private Keys (operation 4023) or other similar data which might require limit on the signal strength i.e. transmission power limiting the broadcast or communication range. The program might also include updating one or more programs or firmware of a device (operation 4024) directly from remote controller such as smart phone or gateway where a high signal strength ensuring a better signal to noise ratio and thus higher or even maximum transmission power is required. The program might also include broadcasting or communicating any data to remote controlling devices (operation 4025 or 4026), including gateway directly or via mesh network which might need specific signal strength, thus signal transmission power defining RSSI between two or more devices for effective communication.

As suggested in operation 4026 through 4029, the gain can be adjusted by setting one or more parameters in a controller/processor, a controller controlling the transceiver circuit and/or antenna circuit or a combination thereof. The gain be set with a specific program either running as a part of the firmware in any such one or more controllers or a combination thereof, during the manufacturing process itself or at site with a firmware update process or by running a specific program from a remote controlling device including having a user interface to set a specific range in terms of a broadcast or communication distance or transmission power, gain, signal strength, or RSSI value or a combination thereof. To do so the user can use a user interface on his controlling device and open an Edit Transmit Range or a similar program to edit the gain i.e. signal strength related parameters of the device. The program that is running can dynamically set the gain based on various parameters as a part of the program itself. The parameters such as signal strength, type of power, the battery charge, RSSI value, type of the program, etc.

The controlling device then would be able to change the Gain parameters and get an acknowledgement of the same from the device. Such settings or parameters can be adjusted either directly or via a mesh network from the controlling devices including but not limited to smart phone, remote controllers, gateways, etc.

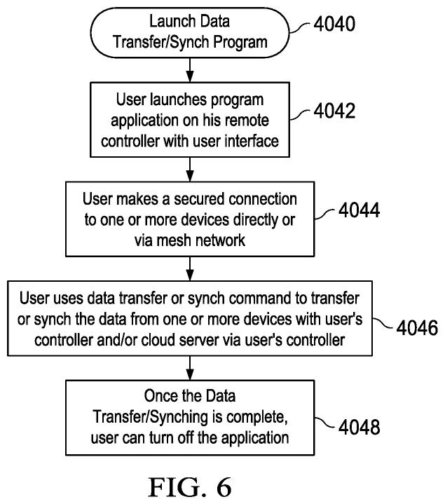

The keys or data stored in memory of the device can be transferred to other memory devices including user controlling device such as smart phone, gateway or a server communicably coupled to the devices, remote controlling devices wired or wirelessly, including via intranet or internet. As explained in FIG. 6, the user can connect to one or more devices directly or via a mesh network as in operation 4044 and depicted in FIGS. 14 and 18. It sends a command using the device user interface for data synching. With that, the data can be downloaded either on the user controlling device or it can be uploaded to the server via intranet or internet. Such data transmission or synching can happen with the direct communication between a controlling device (depicted in 4104) and the device (4106) with data or via a mesh network in between.

Now referring to FIG. 6, a flow chart of data synching flow in accordance with one embodiment of the present invention is shown.

As explained previously, the devices above can be in the form of intelligent illuminating devices such as bulbs, strips, fixtures, etc. or in the form of wearable devices such as watches, badges, cards, key fobs, wristbands, sensors, dongles, smart plugs, wall plugs, etc.

or any other form factor. Devices can have one or more LEDs or vibration circuit for usage as indications. Devices can have one or more buttons for configuration, reset or running any other programs on the device. Devices can also have one or more sensors such as accelerometer, motion sensor, occupancy sensor, light sensor, GPS, altitude sensor, etc. The accelerometer can be used for fall detection. Fall detection along with the contact tracing is a specific application for patients in hospitals, elderly people in nursing homes, and other such commercial or residential or industrial venues

In a specific tracking application, LED indications or vibration circuit in a device can be used to notify users or people around it. For e.g.,

If a mobile device collecting the keys finds a match with a key transmitted by the one or more mobile devices (includes wireless device such as wearable device) around, the LEDs can be used to indicate such a match by having them run a specific color, brightness, effect or a combination thereof. Such parameters for matching algorithm can be there as a manufacturing level setting or a user defined program, or a combination thereof.

The device can have a real time clock, timer or counter communicably coupled to the controller/processors or part of controller/processor as defined in previous related patents. The timer, counter or real time clock is used
1. To define specific length of time for which the keys can be stored in a memory
2. To calculate the duration for which the one or more keys have been received from a nearby device and thus
3. To have controller/processor broadcast or communicate one or more keys or data messages within a specific time limit or having a specific duration limit as part of one or more programs
4. To add stamps, flags or data fields in a key related to time, date, duration or a combination thereof.

One or more buttons, one or more switches including but not limited to selection or position switches, touch buttons, flip switches, one or more color LEDs can be a part of the device. The switches clicking or toggling or positions along with LEDs indications can be used to:
1. Select gain value to adjust the range or signal strength
2. Adjust the duration, or one or two Time parameters, including but not limited to the maximum duration for which any key should be stored in a memory before deleting it
3. Reset the device
4. Change other configurable parameters

The way to achieve it is by pressing or toggling one or two switches in a specific pattern such as the first switch pressed twice at about one second interval to select the a parameter required to be changed and then pressing that switch for about 5 seconds to enter into the parameter switching.

FIGS. 7A, 7B, 7C show various programs and settings configurations on user interface. User can enter these settings on the user interface provided to interact with the devices on his controlling device.

The example form factor of the device will now be described further for the proposed application.

As shown in FIG. 8, the device will include a power supply with AC or DC power source via 4078 or 4073. The device may include AC/DC or DC/DC conversion to power the electrical components including controller/processor, real time clock, etc. There can be rechargeable or non-rechargeable battery or such energy storage device including but not limited to super capacitors. Such energy storage devices provide power to controller/processor or real time clock or other part of the electrical circuit when there is no power from the constant AC or DC source powering the device. The LED indicator can be used to showcase the battery status. For an example, the LED indicator blinks a few times, say 5 times after specific intervals, say every 20 seconds when the charge drops to a specific value, say 40%; and it can blink faster with a specific color, say a red color for a few seconds after every specific duration say 10 seconds. The LED indication can be different in terms of blinking frequency to keeping it solid for a specific time period to indicate various charging levels. In case of a rechargeable battery, the indicator can show a specific indication while charging via a power source.

The device can have two parts of the system as shown
1. A power supply that has power generating ability, built in power/electrical charge or that can be connected to a power source
   a. This can be AC/DC or DC/DC power supply such as phone charger
   b. It can be a battery
   c. It can be solar based energy device
   d. It can be a wireless energy-based device
   e. The power source can have connector or cable or a combination thereof for connecting to the actual power source
   f. The power source can have mating connector (4080) such as USB female connector to connect to a controller board which can be an external board.
   g. Enclosure
2. Controller Board that has the control circuitry with a combination of various parts
   a. Controller/Processor and related circuitry
   b. Real Time Clock
   c. Chargeable or non-chargeable energy storage device such as battery or super capacitor
   d. DC/DC converter
   e. AC/DC converter
   f. Transceiver circuit
   g. Antenna
   h. Enclosure
   i. LEDs (4076)
   j. LEDs control signal or LED current control circuitry
   k. One or more Buttons or Switches including, but not limited to, push buttons, touch buttons, flip switches, etc. (4074)
   l. Memory
   m. Any sensor
   n. Mating connector or cable or a combination thereof to connect to the power supply such as Male USB connector

All above as also suggested in earlier patent referenced in this patent application. Form factors can also be intelligent illuminating device as explained in previous patents referred in this application. Furthermore, the controller board or controller circuit as in the part two of the above device can be used in any other form factor including wall plugs, just standard wireless repeater, gateways, remote controllers, dongles, etc.

The two parts of the system defined above can be put in one part itself. The two parts of the device above can be in two separate enclosures or part of one enclosure.

The need and the process to update the timing in the devices will now be explained.

Updating Time and/or date in controller/processor based on Timer, Counter and in Real Time Clock can be achieved as explained in patent application US20170011621A1, which is hereby incorporated by reference in its entirety. Also, the time synching for counter and timer based devices (without real time clock or battery or other energy storage device such as super capacitor) can be achieved by having a device with Real Time Clock with battery or other energy storage device such as super capacitor also called as supercap. The processor/controller can have a built in Real Time Clock or Timer/Counter in thee processor/controller can be used to implement a Real Time Clock application. In such scenarios, the device with real time clock and battery or other energy storage device broadcasts or communicates the present or the latest time and/or date with other devices at specific intervals or as per user commands or programs. The controlling device with the latest or present time also broadcasts or communicates the time and/or date information to the devices running programs dependent upon real time clock, timer or counter as one of the programs explained above where keys are deleted after a specific time interval or duration. Such time synching is required in case the power to the device are turned OFF (not getting external power) and the counter, timer or real time clock in the device doesn't have a backup energy source such as battery to keep running or it's a rechargeable energy source and the charge has ran out by the time the device was powered back ON. The broadcast messages can be received by device directly or via a mesh network. The time/date synching can be a part of other programs as well such as but not limited to scheduling a device, commissioning or performing a setup process, firmware update, or any other commands.

A specific application for contact tracing will now be explained in association with the above processes, technology, and devices. The contact tracing is an important tool to combat epidemics or other disasters. In many cases the two users would exchange a private key when they are together and nearby within the wireless communication range. However, in a scenario where the second user comes at a venue just after the first user had left the venue, no key is exchanged between them (their mobile devices). Now consider an epidemic is going on and the second person is diagnosed infected after ten days. As in the first scenario where the keys are exchanged by two users, and assuming there is a way to inform the server the key of an infected user from where other users also uses the stored keys in the server to compare them with the keys stored in his mobile device stored during the key exchanges, the other user would be able to confirm that he/she was in contact with the other person on this day and at this time and at this location as in some sophisticated protocol such as Decentralized Privacy-Preserving Proximity Tracing (DP-3T). However, in a second scenario, where two users visit the same place but at different time, any user would not be able to know that the other person was at the same location even if at a different time. This is a crucial information in various cases such as the infection can be transmitted to a user via surfaces touched earlier by the infected person.

It is solved by having the device installed, say a static device at a location as explained earlier.

Below is one of the processes of how the key exchanges, retrieval, and comparing would work.

A wireless device will scan for any incoming keys or messages and filter it out based on the one or more identifiers.

There can be more than one filters as below but not limited to:
1. Name or Unique Identifier:
   For example, an identifier can be either name or some given unique identifier or SIG Service UUID in the case of Bluetooth.
2. RSSI Value:
   Users can define certain minimum and maximum RSSI values to filter the incoming messages.
3. Number of times a key or message is received.

Once filtered, the key or message will be stored in a devices' memory as it is or with additional stamp, flag or additional data field or a combination thereof explained earlier on the device itself.

Each device in this case can consist of the Real Time Clock (RTC), Timer, or Counter which will provide accurate current time, say with respect to the UTC time. The device will have configurable time values such as but not limited to
1. Frequency of rebroadcast: This time value will allow the user to set the frequency of the rebroadcast of the key or message received.
2. Broadcast Life (Duration): This time value will allow the user to set the time until what duration the key or message should be broadcasted with the set frequency.

The device will have the ability to set the configurable wireless signal strength dynamically. This will allow the user to change the range of the signal.

Keys or Messages would be stored sequentially, randomized, based on the user defined dynamic storage, pre-defined dynamic storage, or as per one or more programs, or a combination thereof. The keys or messages would be stored only for until defined time or duration say 6 hours since the key was received and then the keys or messages are deleted as first in first out basis or based on some other parameters such as severity, priority, etc. explained earlier.

The above part will ensure the keys or message are getting stored and deleted in device. Now, in the second part of the process, the keys or messages stored in the memory need to be retrieved and broadcasted or communicated to mobile devices such as with people carrying with them when they visit the location and are nearby the device installed. There would be a retrieval and broadcast or transmit of stored keys or messages based on below but not limited to parameters.

duration

start time

end time

trigger based such as when the user arrives and broadcasts its key or message via a mobile device

the way keys or messages are stored

any user default or defined one or more programs

The keys or messages may consist of flags, data fields, etc. as described previously. This way the mobile device of a visiting person would receive all the keys or messages and store them in his mobile device or on the cloud server via internet connection.

Both the parts of the above processes i.e. the device receiving and storing the keys or messages and the device retrieving and broadcasting or communicating/transmitting the keys or messages can be either:

Sequential

Simultaneous

Event based

Trigger based

User Defined time based

User defined counter or timer based

User defined scheme based

Based on the default settings set during the configuration

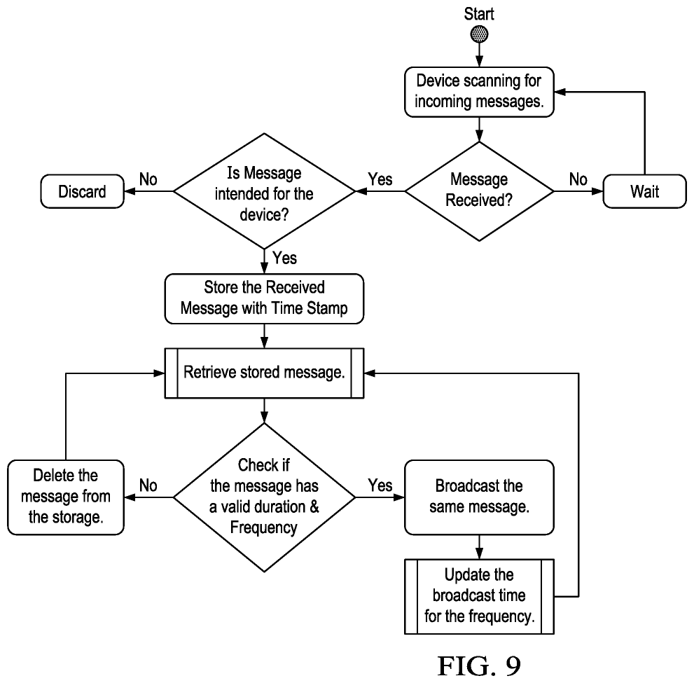

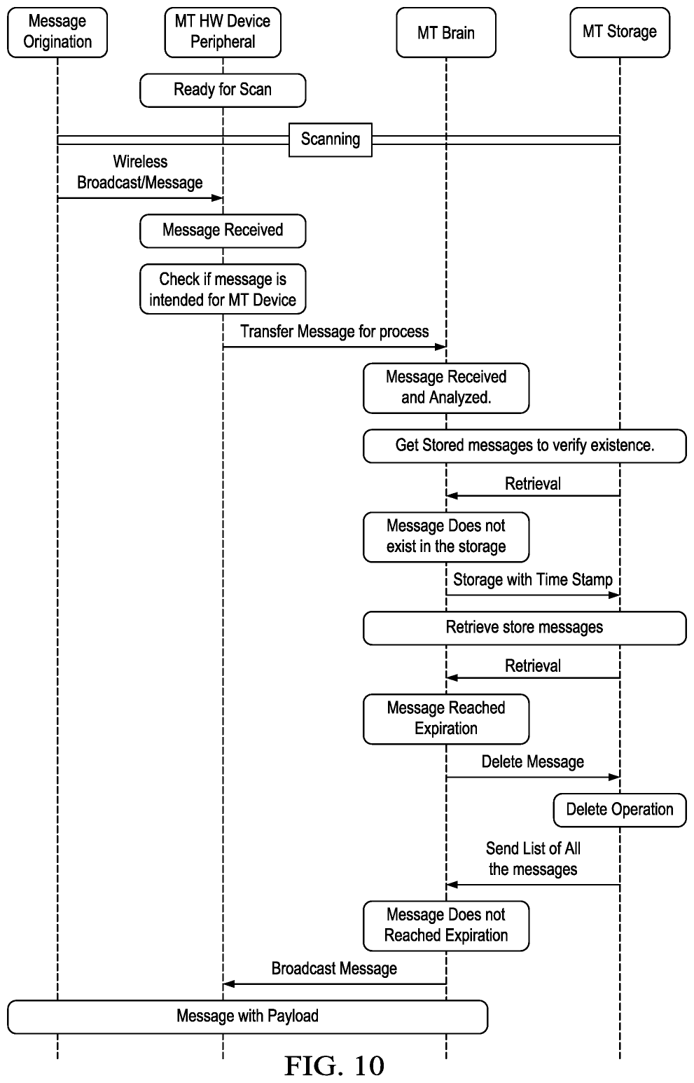

This way the mobile device will also receive the keys or messages with potentially more information of people visiting the same location previously. This data with various keys can be used by additional system in place that allows the comparison of all types of keys or messages from static or mobile device with the keys or messages from infected person's mobile device. An example flow chart and process flow are shown in FIGS. 9 and 10, respectively.

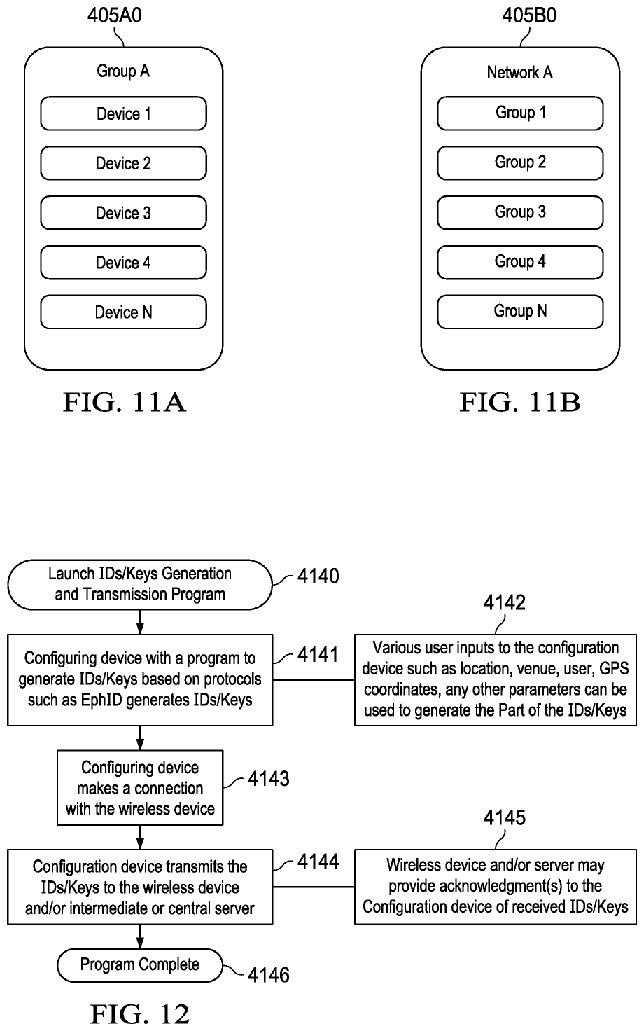

FIGS. 11A and 11B shows the various Devices in various Groups on a user interface. A user can select any one or more devices individually or groupwise and send various programs as in FIGS. 7A, 7B, 7C. Previous patents referred in this application describes these processes in detail.

Exposure Notification or Proximity Tracing

Exposure notification or Proximity Tracing is being used for various technology based tracing and tracking such as for virus such as Covid19 infection tracing, inventory tracking, etc. Decentralized privacy protected rotating key generation on the smart phones such as with Decentralized Privacy-Preserving Proximity Tracing (DP-3T) protocol or Pan-European Privacy-Preserving Proximity Tracing (PEPP-PT), Pan-European Privacy-Preserving Proximity Tracing (PEPP-PT) protocol can be used to for such exposure notifications. It is used in wireless protocols such as Bluetooth to track and log encounters with others.

The exposure notification protocols such as DP-3T protocol works off the basis of Ephemeral IDs (EphID), semi-random rotating strings (also known as data key in a broadcast packet) at every defined time interval such as 10 minutes that are unique to the clients so identifiable. When two clients encounter each other, they exchange such EphIDs and store them locally in a contact log. For e.g., two users carrying such a smartphone and enabled with such exposure notification software, would exchange the rotating keys broadcasted on the Bluetooth protocol from each other and store them in respective smartphones. Then, once a user tests positive for infection such as Covid19, a report is sent to a central server. Each client or such users on the network are regularly collecting the reports from the server and independently checking their local contact logs for an EphID contained in the report. If a matching EphID is found, then the user has come in close contact with an infected patient, and is warned by the client as per the software running on the smartphone. Since each device locally verifies contact logs, and thus contact logs are never transmitted to third parties, the central reporting server cannot by itself ascertain the identity or contact log of any client in the network, thus it is quite impossible to track the location or any other personal information of the user without his/her consent. With encrypted and rotating keys, local (smartphone) storage (decentralized storage) of received keys, comparison of infected keys pushed from the central server locally provides the stringent privacy protection. The major challenge for this to make this exposure detection work, the user has to have a communication with the server, which potentially is via continuous internet connection. Thus, two major limitations of the exposure detection can not be solved:
1. Airborne and fomite infections/virus transmissions: This is when one user visits an infected place such as a restroom where virus say Covid19 is in the air for a few hours or on various surfaces such as doorknobs for days, from the previous visitor visiting such place found infected. This is because, as two users are visiting the same space at different times, there is no exchange of keys between them.
2. Users who don't have access to a device with such exposure detection software running on it such as smartphone such as students in a school, people who can't afford it, elderly people in nursing homes, etc.

There are similar limitations for other applications such as inventory tracking, patient tracking in hospitals with similar exposure detection software.

A two-part solution for the above problems will now be provided. It can be used individually or in a combination.
1. A wireless device (battery based, direct AC/DC power based, solar based) capable of any of the following or a combination of
   a. Processor communicably connected to wireless integrated circuit and antenna
   b. Capable of creating Ephemeral IDs or other equivalent IDs or keys (IDs or Keys). Note that IDs or Keys can be any other type of Keys with defined pattern and may contain specific parameters such as location, time, date, various identification numbers identifying the user or device the wireless device is connected to, network information, any sensor data, etc.
   c. Capable of receiving and storing one or many Ephemeral IDs or other equivalent IDs or keys generated by other one or more devices
      i. Such as a wearable device (various form factors such as a wristband, a key-fob, a badge, a card, a watch with Bluetooth protocol able to receive IDs or keys from a smartphone app while commissioning)
      ii. All other devices referred in this document
   d. Able to wirelessly broadcast such IDs or keys such as Bluetooth broadcasts
   e. Able to receive and/or store broadcasted such IDs or keys from other devices
   f. Able to compare the sored or received IDs or keys
   g. Able to recharge
   h. Able to get power from a DC or AC power source
   i. Able to show various statuses on a LED indicator or vibration circuit
   j. Able to adjust the transmission power and thus the broadcast range
   k. Able to form a mesh network with other devices on the same wireless protocol such as Bluetooth including a device that can be connected to the server with internet connection such as WiFi, Ethernet, Cellular, etc.
   l. Able to replace a battery
   m. Can have various form factors such as dongle, bulb, wall plug, sensors, lighting fixture, wearables such as wrist watch, wristband, key-fob, badge, card, watch, etc.
   n. Able to connect to other devices such as computers, smartphones, gateways, wired (such as USB connector) or wirelessly, for configuration, commissioning, data or transmission, communication, etc.
   o. Has one or more buttons or switches
   p. Digital display such as LCD
   q. Real Time Clock or Timer to know the current date/time and broadcast IDs or Keys as per the specific timing or timing interval requirements
   r. Able to notify battery charge or the capacity as an indication on itself or wireless communication
2. Configuring device such as smartphone or computer with a software application that is capable of any of the following or a combination of
   a. Able to generate IDs or Keys and transmit those to the wireless device from 1. above with wireless or wired communication
   b. Able to communicate the generated IDS or Keys to a central server or other intermediate server along with various parameters explained below and in 1.
   c. Able to configure or commission the device from 1. with
      i. IDs or Keys
         (1). IDs or Keys can be associated with the specific user, organization, entity, program, application, or other parameter defined by the user or configuring personnel
      ii. Date and Time
      iii. Location ID such as or a combination of
         (1). GPS coordinates
         (2). Specific venue such as restaurant A in a mall
         (3). Beacon or Device ID
      iv. Login ID and/or Password for authorized access
      v. Transmission power
      vi. Various programs such as schedules, dynamic IDs or Keys broadcast
      vii. Firmware upgrade
      viii. Storage or memory parameters for IDs or Keys received from other devices
      ix. Broadcast parameters such as interval of broadcasts
      x. IDs or Keys rotation parameter such as interval when key changes
      xi. Storing or broadcasting IDs or Keys generated with various user provided or generated by a configuring device such as GPS location, venue information, installer information, network information, device information, broadcast or timing parameters, etc.

The process of setting up the wireless device with IDs or Keys is explained as per the flow diagram of FIG. 12.

The configuration device such as smartphone with the configuration app connects with the wireless device such as with the pairing process with Bluetooth protocol. The configuration device either generates the IDs or Keys with the algorithm running on it or fetches the IDs or Keys from the remote computing server and transmits those to the wireless device and/or intermediate or central server. The wireless device and/or intermediate or central server may provide acknowledgements to the configuration device and vice versa. The configured device can also generate IDs or Keys with program or algorithm running on it and using the parameters set by the configuring device during the configuration process.

The IDs or Keys can be associated with the time of the day and the days of the week or specific dates. OR IDs or Keys might have a few fields specifying the time and date parameters, and other parameters such as location, device IDs, device type, specific user information including user ID it is associated to, and the wireless device it is connected to.

The wireless device can also generate the IDs or Keys and transmit those to the intermediate or the central server.

Furthermore, the configuration device might just provide one or more parameters such as but not limited to date, time, sensor date, location information, network information, device or users the wireless device is associated with, etc. to the wireless device and or/remote computing server and/or intermediate server or central server. The parameters can be used to generate the matching or associated IDs or Keys on the wireless device and/or any of the servers. This can be achieved by running similar algorithms and codes to generate the IDs or Keys on the devices or servers. This way the transmission/communication from the configuration device and vice versa to wireless device is limited and can save installer's time configuring the wireless device. The IDs or Keys on the wireless device and the remote servers, intermediate server or central server can be used for comparison, validation and tracking purposes.

The battery based wireless device will need additional software algorithms to run on low average power and elongate the battery life. In such cases, the wireless device can be put to work in the following fashion
1. Run the IDs or Keys generation only when commanded by the configuration device or as per the program restricting it to the number of times or specific times.
2. Broadcast the IDs or Keys at higher interval of times adjusted for elongated battery life.
3. Listen to incoming messages or commands at specific interval of times or for a period of time after listening to the specific type of command

The process to configure the wireless device with various parameters is provided below:

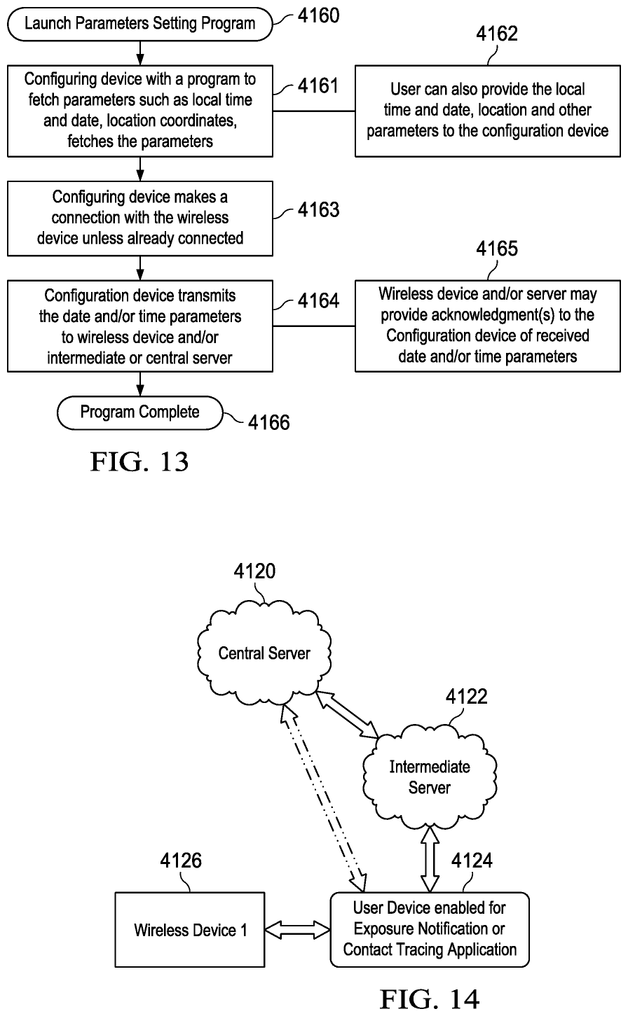

As shown in FIG. 13, the wireless device need to be configured with various parameters such as but not limited to time, date, location parameters, sensor data, device or user data the wireless device is associated with, network parameters, login ID and/or passwords, installer parameters, etc. as in operation 4161, 4162.

The configuration device fetches such data from the internet or the user provides it via a user interface and the configuration device transmits such parameters in a specific format to the wireless device as in operation 4163 and 4164. The Wireless device might acknowledge the receipt of such parameters to the configuration device as in operation 4165. The parameters can also be transmitted to the remote servers, intermediate or central servers for future comparison and validation purposes.

Resetting the wireless device will now be explained.

The wireless device can be reset of various parameters or to specific setting such as manufacturing default settings via buttons present on it or commands from the configuration device.

Exposure Notification or Contact Tracing Solution will now be explained.

The process of how exposure notification or contact tracing process with devices without internet connection works is explained below with respect to virus infections spread.

Consider that a wireless device 4126 is installed in a restaurant and configured with Keys associated with the time and/or location IDs as explained above. The wireless device constantly broadcasts the keys as per the program and the parameters set. The receiving device 4124 such as a user smartphone, other wearable device enabled for exposure detection or contact tracing application receives such keys. The keys are stored on the smartphone or the device 4124. In the future, if a contact tracer say a person hired by a health agency finds an infected person and in case that person had visited the restaurant where the wireless device is installed, the contact tracer or an authorized person based on the time and/or the location of the visit, with the help of the software can sort out the keys broadcasted from the wireless device and push them to the intermediate server 4122 and eventually to the central server 4120 as infected keys. The keys can be pushed to the Central Server directly; the intermediate server provides additional security and decentralized operation if required. These keys can further be assigned with parameters such as severity, importance, etc.

Now referring to FIG. 14, a block diagram of contact tracing application data flow in accordance with one embodiment of the present invention is shown.

The user device such as smartphone is regularly or as required downloads such infected keys from the central server or the intermediate server and compares with the keys it had received by when he actually visited the location at the specific time. If the match between the keys received from the wireless device and the infected keys received from the server is found, the notification can be seen on his smartphone notifying a potential risk of virus infection as he visited the infected place.

The infected keys can be defined by various parameters such as but not limited to the time when or further additional time when the infected person visited the location, distance from the one or more wireless devices in the location such as restaurant in the above example.

In case there is a gateway 4188 connected to one or more wireless devices, the IDs or Keys can be received from the user's device such as Smartphone and can be passed on to the intermediate server 4182 or the central server 4180 as required for the future validation or comparison, and notification. This can be achieved by using a mesh network between various installed or configured devices 4186 as well.

This approach can be used for various monitoring and tracking purposes such as but not limited to students tracking in schools, elderly people tracking in nursing homes, patient tracking in hospitals, equipment tracking in a facility, etc.

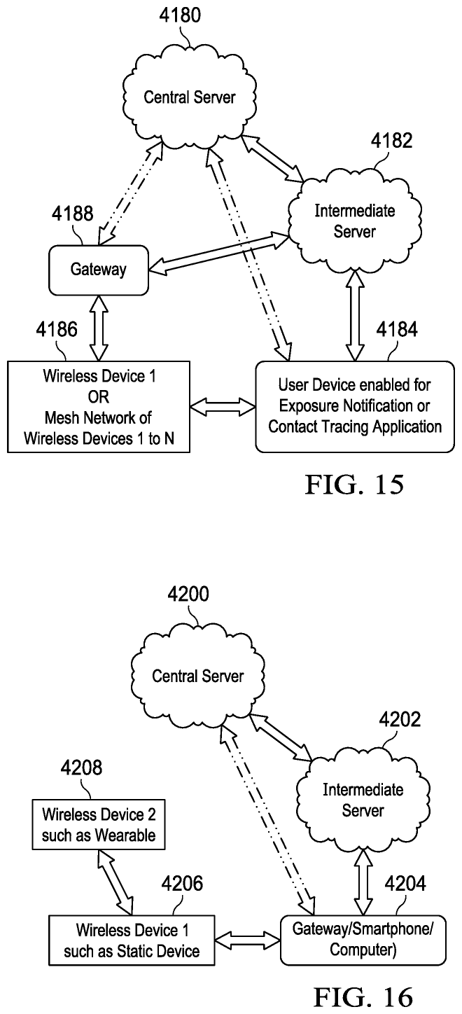

FIG. 15 is a block diagram of contact tracing/exposure notification application process in accordance with one embodiment of the present invention.

FIG. 16 is a block diagram of wearable device synching keys via powered device in accordance with one embodiment of the present invention.

Enhancement of Exposure Detection or Contact Tracing using Wearables with no Internet Connection:

Furthermore, the wireless device such as wearables such as wristbands, tags, key-fobs, badges can be used not just for below purposes specifically or in a combination:
1. Receiving the IDs or Keys
2. Broadcasting or transmitting the IDs or Keys
3. Receiving and Broadcasting IDs or Keys simultaneously
4. Generating IDs or Keys

In case, users don't have a wireless device such as smartphone capable of communicating to the intermediate or central server directly, a wearable wireless device without internet connection and another wireless device capable of connecting to the intermediate or central server can be used to pass on the received and stored IDs or Keys from the wearable wireless device to the intermediate or central server via a wireless device capable of connecting to the intermediate or central server.

An example of Devices such as Wearable Device (4208) transmitting the IDs/Keys to the Server (4202 or 4200) via Gateway or Smartphone or Computer as part of the exposure notification or contact tracing system is shown in FIG. 16. In this case, the Static Device 4206 such as Wall Plug can query the nearby Wearable Device 4208 for any keys available in his memory which are to be synched with the server. Wearable Device can verify if it is allowed to connect to such Wireless Device 4206 by running authorization program which can be matching some parameter by communicating with the Wireless device 4206, and connect if authorization program passes the authorization test. Once connected, the Wearable Device 4208 can synch the keys it has with the Wireless Device 4206 by establishing a communication link. Once the required Keys or IDs are received, by the Wireless Device 4206, an acknowledgement is shared to stop the program. Furthermore, the Wearable Device 4208 can delete the Synched Keys based on the acknowledgement to free up its memory. The Wireless Device 4206 further passes the Keys or IDs to the Central or Intermediate server with the similar synching process via the authorized Gateway, Smartphone or Computer (4204) which is connected to the server vial local or internet network. The Gateway/Smartphone/Computer 4204 can also provide an acknowledgement to the Wireless Device 4206, in turn, to the Wearable Device via the Wireless Device 4206, which can also be used to delete the Keys or IDs from Wireless Devices 4208 or 4206 to free up the respective memories.

The Wearable Device 4208 can also Synch the Keys or IDs with Gateway/Smartphone/Computer 4204 directly instead of requiring any intermediate Wireless Device 4206. Furthermore, the Wearable Device 4208 can also Synch the Keys or IDs with Gateway/Smartphone/Computer 4204, in turn with the server 4200 or 4202 via a wireless mesh formed by two or more Wireless Devices 4206 in a mesh network, also depicted in FIG. 15.

This approach can be used for various monitoring and tracking purposes such as but not limited to students tracking in schools, elderly people tracking in nursing homes, patient tracking in hospitals, equipment tracking in a facility, etc. The Keys or IDs can be anonymous and associated with users only and the comparison or exposed Keys or IDs can be achieved on user's device, private/authorized server locally or remotely, giving privacy protection.

A school scenario now will be explained to elaborate further the user case:

The wearable wireless device gets or itself generates the IDs or Keys as explained beforehand. The wearable device is given to a student. A teacher or a parent has a smartphone device with IDs or Keys program and capable of connecting to an intermediate server or a central server.

The wearable device can receive IDs or Keys broadcasted or transmitted from other similar wearable device(s) or smartphones running the exposure notification or contact tracing software.

The wearable device after receiving the IDs or Keys stores those in its memory either internal to the processor of the wearable device or communicable coupled to the processor of the wearable device. A smartphone or a computer as a part of the exposure detection or contact tracing system with authorization to communicate with the wearable device(s) can connect to the wearable device(s), get all the stored keys in a specific time period and either stores it in its memory or gives to the intermediate or central server(s) as and when required, defined as per the process and algorithms or processes explained in this document. The transmitted keys can be associated with the wearable device ID or the student or other associated parameters defined beforehand.

With this, when infected keys are found or recognized, can be compared with stored keys or transmitted keys from the student's wearable device which were in turn received from other wearable or wireless devices running exposure detection or contact tracing software. The comparison can lead to potential risk of student exposed to the infected person (using wearable device or smartphone with exposure detection or contact tracing software) or the place (installed with wireless device with exposure detection or contact tracing software), as part of the overall system.

When the wearable device is communicably coupled with the smartphone or a computer able to communicate with the intermediate or central server where infected keys are stored, the smartphone or the computer can compare the keys received by the wearable device with the infected keys available on the server and conclude the potential exposure to the infection. Instead of smartphone or computer, another wireless device such as gateway capable of communicating to the intermediate server or the central server can also be used for facilitating such keys comparison.

An indicator such as LED indicator can be lit with specific color, brightness or a pattern as an alarm indicating the exposure to the virus infection. Smartphone, computer or other server connected wireless device can also show the exposure either via user interface, sound, or LED indications on them. Furthermore, a notification in the form of a text or email or the likes can be sent to the user or person or entity authorized by the user. Such association is formed while configuration process and email, phone number or other communication channel information is also stored on the server for the future notification usage.

The above process can be used for various purposes such as tracking the movement of the patients in a hospital, tracking equipment in a factory, tracking students in a school, exposure detection of people and or equipment to specific places or people in given times, etc.

The similar applications and approaches explained in this document can be used with Wireless Device with Sensors capable of broadcasting IDs or Keys:

The wireless device(s) as explained above can have various sensors such as but not limited to:
1. occupancy sensor
2. light sensor
3. air, CO₂ or other gas sensor(s)
4. temperature sensor
5. humidity sensor
6. presence sensor
7. chemical sensor
8. sound sensor

The broadcast of keys can be triggered based on the trigger from the sensor. For e.g., the IDs or Keys can be broadcasted for a specific period of time only when an occupancy sensor senses a person in the vicinity or in a given range and provides a trigger to the processor it is communicable coupled with. The processor of the wireless device senses such triggers and can allow the wireless device to broadcast or transmit the ID(s) or Key(s) once or specified amount of time or for specified times in a defined interval of each broadcast.

In this case, the Broadcast Keys or IDs can be a message containing various information such as but not included
1. Server routing information
   a. This basically tells the main server where such data should be routed to
   b. It can be routed to the server of another entity or user
2. Sensed data
3. Device ID
4. System ID
5. Location data
6. Various other parameters referred in this document

Such Keys or IDs can be messages which are formed with anonymous keys and encrypted.

The sensor can be part of the wireless device itself or the sensor can be a wired or wireless sensor independent or part of other electronic system and can be communicably coupled with the wireless device wirelessly or wired.

The memory optimization process while storing and broadcasting processes will be explained below.

In all above applications, the wireless device might have limited memory and only a limited quantity or IDs or Keys can be stored on them in case local generation of keys is not being used. In that case, the keys can be reused. For e.g. if 100 IDs or Keys are stored in a wireless device to be used for every 10 minutes, the keys would be unique only for up to 1000 minutes. After 1000 minutes the 100 keys can be reused in the same sequence or a different sequence defined by the program. The IDs or Keys reuse can be timed based on monthly, weekly, date wise or other such timing parameters.

The IDs or Keys can also be automatically deleted after the usage or as per the program. This way, one can not trace the IDs or Keys and associate for any unauthorized tracking.

Real Time Clock (RTC) usage and synch in the wireless device(s)

An important part of the RTC is to ensure the IDs or Keys are broadcasted or transmitted at specific time, day or date. It is important to do so to ensure the other associated receiving devices or servers recognize the time, day or date of IDs or Keys received for accurate tracking, contact tracing or exposure detection as per the application requirement. Thus, ensuring the RTC has right date and time is an important aspect of the solution. Or in case the RTC time or date is off or incorrect, the solution should be able to take care of false IDs or Keys being transmitted creating potential false alarms. To solve such scenarios various solutions will be discussed as below:
1. The IDs or Keys can have some parameters to associate with the time and/or day and/or date when they can be broadcasted or transmitted. For an example, a data byte in the ID or Key might associate the key to be broadcasted at between 10:00 a to 10:10 am on Wednesday. In case the RTC time is off with respect to the time and/or day associated with the key, the processor can execute another program such as stop broadcasting or transmitting, set an alarm with LED indicator or a specific broadcast message suggesting RTC time off, check with other nearby Wireless Devices including Gateways, etc.
2. The RTC can store it's date and/or time in a memory location in the Wireless Device regularly, say every minute for an example. And before broadcasting or transmitting the IDs or Keys, it checks the current time is within the one minute with some error percentage. In case, the it is not the specified limit, one minute in this case, RTC is off and a proper action such as explained in 1. can be taken by the processor. The time in the processor can also be used to calculate the such timing for comparison and calculations.
3. The Wireless devices around other devices can ensure the approach in 2. above or a similar approach that ensures the current date and/or time of its RTC is fairly accurate, can transmit the Set Time Command to other Wireless Devices around either directly or through a mesh network. What Set Time Command does is it provides the fairly accurate time to the Wireless Devices around and the receiving Wireless Device(s) can update their current date and/or times with that.
4. The Wireless Device which is connected with the internet or a server from where it is able to update its current date or time can also sent Set Time Command to the Wireless Devices. This command can override the current time of the Wireless Device(s) whichever receives such command. There could be a Wireless Device such as Computer with robust and reliable RTC or Timer with accurate real time and date and may not be connected to any server network including via internet. However, it can be assigned as a master RTC device by user or as a manufacturing default. Such a device can also regularly update the time and/or date of other Wireless Devices around it directly or via a mesh network.

5. Time and/or Date can be shared among the devices in a local network directly or via Mesh. Each time associated with a Wireless Device ID received by a Wireless Device will be stored in memory locations and the maximum no. of received time and date information which are same or within the allowable difference from the average or medial time or date information are selected and median or the average of those time and/or date is taken as the correct time and date. This process happens every specified time of the day or at some interval. This process can also be triggered in case of points 1 or 2 happen.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

1. A device comprising:
a wireless transceiver;
a memory;
a processor communicably coupled to the wireless transceiver and the memory, wherein the processor receives one or more electronic keys from one or more wireless devices, and stores the one or more electronic keys in the memory; and
wherein the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value.

2. The device as recited in claim 1, wherein:
the one or more electronic keys further comprise a device identification, an anonymous identification, or a person identification; or
the one or more electronic keys are encrypted.

3-4. (canceled)

5. The device as recited in claim 1, wherein the processor adds a data, a flag or a stamp to the one or more electronic keys, and the data, the flag or the stamp comprises a second identifier, a location, a time, a start time, an end time, a date, a duration, a signal strength, a frequency, a severity, a device type, a transmission power, a RSSI vale, a GPS coordinate, a version number, a sensor data, or a priority value.

6. The device as recited in claim 5, wherein:
the processor increases or decreases the priority value of the electronic key based on a number of electronic keys received from one of the wireless devices; and
the priority value comprises a numerical value, a flag value, or a memory location.

7. (canceled)

8. The device as recited in claim 1, wherein the processor deletes at least one of the one or more electronic keys stored in the memory whenever the memory has reached a defined storage limit.

9. The device as recited in claim 1, wherein the processor selects the at least one of the one or more electronic keys for deletion based on a duplication of electronic keys, the duplication of electronic keys within a time period, a number of duplicate electronic keys within the time period, an elapsed time from receiving the electronic key, a priority value associated with the electronic key, a first-in, first-out basis, or a selected data, flag or stamp.

10. The device as recited in claim 1, wherein the processor adjusts a signal strength or a RSSI value between the one or more wireless devices such that additional electronic keys are not received from the one or more wireless devices or are filtered out.

11. The device as recited in claim 1, wherein the processor transmits, uploads or synchronizes one or more of the electronic keys or data stored in the memory to a server or user device simultaneously, sequentially, based on a priority value, a trigger, an event, a user-defined setting or a default setting.

12-15. (canceled)

16. The device as recited in claim 1, wherein the processor adjusts a signal power of the transceiver to limit, increase or decrease a range.

17-18. (canceled)

19. The device as recited in claim 1, wherein the device or the one or more wireless devices comprise a sensor, a beacon device, a tracking device, a mobile device, a wearable device, a controller, a phone, a gateway, an access point, a repeater, a computer, a lighting device, a wall-mounted device, a ceiling-mounted device, a floor-mounted device, a plug, or a dongle.

20. (canceled)

21. The device as recited in claim 1, wherein:
the processor receives one or more computer programs from a user device having a user interface and running a computer application; and
the one or more programs, when executed by the processor, adjust a gain, adjust a transmission range, reset the device, synchronize a date or time, update a firmware, reset the memory, edit a group, edit other device configurations, edit broadcasting parameters, edit a network, perform commissioning, preform a setup process, edit user access, set light indications, or set priority configurations.

22. (canceled)

23. The device as recited in claim 1, wherein:
the one or more electronic keys stored in the memory of the device are compared with one or more additional electronic keys stored on a server or a user device; and
a notification is provided after the one or more electronic keys stored in the memory of the device match the one or more additional electronic keys stored on the server or the user device.

24. (canceled)

25. The device as recited in claim 23, wherein the notification comprises an email, a text message, or an automated phone call.

26. The device as recited in claim 23, wherein the notification includes a link to a website, written instructions, or written information.

27. The device as recited in claim 1, wherein the processor generates additional electronic keys based on one or more configuration parameters.

28. The device as recited in claim 1, wherein a real time clock in the device, one of the one or more wireless devices, or both wireless devices are synchronized with a reference time.

29. A method for transmitting and receiving one or more electronic keys comprising:
transmitting one or more electronic keys using a first wireless device;
receiving the one or more electronic keys at a second wireless device;
storing the one or more electronic keys in a memory of the second wireless device;
transmitting, uploading or synchronizing the one or more electronic keys or other data stored in the memory of the second wireless device to a server or a user device; and
wherein the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value.

30. The method as recited in claim 29, wherein:
the one or more electronic keys further comprise a device identification, an anonymous identification, or a person identification; or
the one or more electronic keys are encrypted.

31-32. (canceled)

33. The method as recited in claim 29, further comprising adding a data, a flag or a stamp to the one or more electronic keys, and the data, the flag or the stamp comprises a second identifier, a location, a time, a start time, an end time, a date, a duration, a signal strength, a frequency, a severity, a device type, a transmission power, a RSSI vale, a GPS coordinate, a version number, a sensor data, or a priority value.

34. The method as recited in claim 33, further comprising:
increasing or decreasing the priority value of the electronic key based on a number of electronic keys received from first wireless device; and
wherein the priority value comprises a numerical value, a flag value, or a memory location.

35. (canceled)

36. The method as recited in claim 29, further comprising deleting at least one of the one or more electronic keys stored in the memory whenever the memory has reached a defined storage limit.

37. The method as recited in claim 29, further comprising selecting the at least one of the one or more electronic keys for deletion based on a duplication of electronic keys, the duplication of electronic keys within a time period, a number of duplicate electronic keys within the time period, an elapsed time from receiving the electronic key, a priority value associated with the electronic key, a first-in, first-out basis, or a selected data, flag or stamp.

38. The method as recited in claim 29, further comprising adjusting a signal strength or a RSSI value of the second wireless device such that additional electronic keys are not received from the first wireless device or are filtered out.

39. The method as recited in claim 29, wherein the stored electronic keys or other data are transmitted, uploaded or synchronized to the server via another device or the user device simultaneously, sequentially, based on a priority value, a trigger, an event, a user-defined setting or a default setting.

40-42. (canceled)

43. The method as recited in claim 29, further comprising adjusting a signal power to limit, increase or decrease a range.

44-45. (canceled)

46. The method as recited in claim 29, wherein the first wireless device or the second wireless device comprises a sensor, a beacon device, a tracking device, a mobile device, a wearable device, a controller, a phone, a gateway, an access point, a repeater, a computer, a lighting device, a wall-mounted device, a ceiling-mounted device, a floor-mounted device, a plug, or a dongle.

47. (canceled)

48. The method as recited in claim 29, further comprising:
receiving one or more computer programs at the second wireless device from the user device having a user interface and running a computer application; and
wherein the one or more programs, when executed by the processor, adjust a gain, adjust a transmission range, reset the device, synchronize a date or time, update a firmware, reset the memory, edit a group, edit other device configurations, edit broadcasting parameters, edit a network, perform commissioning, preform a setup process, edit user access, set light indications, or set priority configurations.

49. (canceled)

50. The method as recited in claim 29, further comprising:
comparing the one or more electronic keys stored in the memory of the second wireless device with one or more additional electronic keys stored on the server or the user device; and
providing a notification after the one or more electronic keys stored in the memory of the second wireless device match the one or more additional electronic keys stored on the server or the user device.

51. (canceled)

52. The method as recited in claim 50, wherein the notification comprises an email, a text message, or an automated phone call.

53. The method as recited in claim 50, wherein the notification includes a link to a website, written instructions, or written information.

54. The method as recited in claim 29, further comprising generating additional electronic keys based on one or more configuration parameters.

55. The method as recited in claim 29, further comprising synchronizing a real time clock in the first wireless device, the second wireless device, or both wireless devices with a reference time.

56. A system comprising:
a first wireless device that transmits one or more electronic keys;
a second wireless device that receives the one or more electronic keys from the first wireless device, and stores the one or more electronic keys in a memory of the second wireless device;
a server or a user device that uploads, receives or synchronizes the one or more electronic keys from the second wireless device; and
wherein the one or more electronic keys further comprises a data, a flag or a stamp comprising a location, a time, a date, a duration, a signal strength, a frequency, a severity, a device type, a transmission power, a RSSI vale, a GPS coordinate, a version number, a sensor data, or a priority value.

57-82. (canceled)
